(19) United States
(12) Patent Application Publication
(10) Pub. No.: US 2022/0295447 A1
(43) Pub. Date: Sep. 15, 2022

(54) NETWORK ACCESS METHOD, APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/770,602

(22) PCT Filed: Oct. 21, 2019
(86) PCT No.: PCT/CN2019/112371

§ 371 Date: Apr. 20, 2022

(51) Int. Cl. H04W 68/12; H04W 48/08

(52) U.S. Cl. CPC H04W 68/12; H04W 48/08

(57) ABSTRACT

The present disclosure relates to a network access method. The method includes: receiving a paging signaling of the second type network forwarded by the access node of the first type network currently accessed by the user device; accessing the second type network according to the paging signaling.

### CROSS-REFERENCE

The present application is a U.S. National Stage of International Application No. PCT/CN2019/112371, filed on Oct. 21, 2019, the entire content of which is incorporated herein by reference for all purposes.

### TECHNICAL FIELD

The present disclosure relates to, but is not limited to, the field of wireless communication technologies, and in particular, to a network access method and apparatus, a communication device, and a storage medium.

### BACKGROUND

In a mobile cellular communication network, a base station instructs a user equipment (UE) to initiate a connection with the base station by sending paging signaling.

In a 5th generation (5G) mobile cellular communication network, new technologies such as beam sweeping based on beamforming are introduced.

### SUMMARY

Embodiments of the present disclosure provide a network access method and apparatus, a communication device, and a storage medium.

According to a first aspect of the present disclosure, there is provided a network access method, and the method includes: receiving paging signaling of a second type network forwarded by an access point of a first type network currently accessed by a user equipment; and accessing the second type network according to the paging signaling.

According to a second aspect of the present disclosure, there is provided a network access method, and the method includes: sending paging signaling of a second type network and first identification information used by a user equipment in a first type network to an access point of the first type network, wherein the paging signaling of the second type network is used for forwarding by the access point of the first type network to the user equipment currently accessing the first type network based on the first identification information; and accessing the user equipment to the second type network according to a received access request of the user equipment.

According to a third aspect of the present disclosure, there is provided a method for transmitting paging signaling, and the method includes: receiving paging signaling of a second type network and first identification information used by a user equipment in a first type network; and forwarding the received paging signaling of the second type network to the user equipment currently accessing the first type network according to the first identification information.

It should be noted that the above general description and the following detailed description are merely exemplary and explanatory and should not be construed as limiting of the disclosure.

### BRIEF DESCRIPTION OF THE DRAWINGS

The accompanying drawings, which are incorporated in and constitute a part of the disclosure, illustrate embodiments consistent with the present disclosure and, together with the description, serve to explain principles of the present disclosure.

FIG. 1 is a schematic structural diagram showing a wireless communication system according to one or more examples of the present disclosure;

FIG. 2 is a schematic flowchart showing a network access method according to one or more examples of the present disclosure;

FIG. 3 is a schematic diagram showing a network architecture according to one or more examples of the present disclosure;

FIG. 4 is a schematic flowchart showing another network access method according to one or more examples of the present disclosure;

FIG. 5 is a schematic flowchart showing a method for transmitting paging signaling according to one or more examples of the present disclosure;

FIG. 6 is a block diagram showing a network access apparatus according to one or more examples of the present disclosure;

FIG. 7 is a block diagram showing another network access apparatus according to one or more examples of the present disclosure;

FIG. 8 is a block diagram showing an apparatus for transmitting paging signaling according to one or more examples of the present disclosure; and

FIG. 9 is a block diagram showing an apparatus for network access according to one or more examples of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the embodiments of the present disclosure and the appended claims, the singular forms “a”, “the” and “said” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, first information may also be referred to as second information, and similarly, the second information may also be referred to as the first information. Depending on the context, the word “if” as used herein can be interpreted as “upon” or “when” or “in response to determination”.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

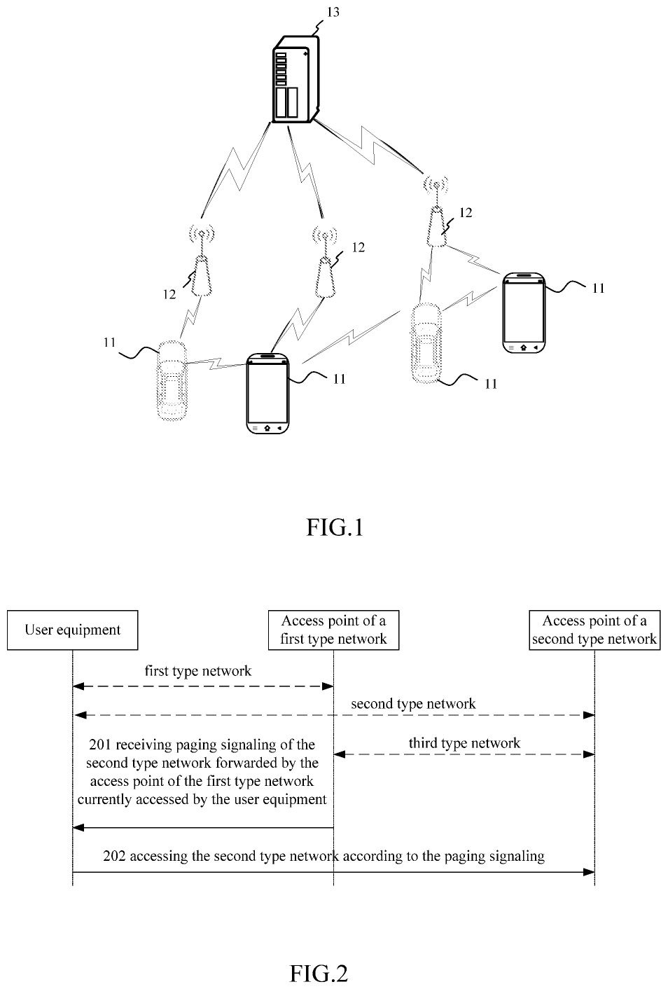

Reference is made to FIG. 1, which shows a schematic structural diagram of a wireless communication system according to an embodiment of the present disclosure. As illustrated in FIG. 1, the wireless communication system is a communication system based on cellular mobile communication technologies. The wireless communication system may include several terminals 11 and several base stations 12.

The terminal 11 may refer to a device that provides voice and/or data connectivity to a user. The terminal 11 may communicate with one or more core networks via a radio access network (RAN). The terminal 11 can be an Internet of Things terminal, such as a sensor device, a mobile phone (or a “cellular” phone) and a computer with the Internet of Things terminal. The terminal may be, for example, a fixed, portable, pocket-sized, handheld, built-in computer or vehicle-mounted device, such as a station (STA), a subscriber unit, a subscriber station, a mobile station, a mobile, a remote station, an access point, a remote terminal, an access terminal, a user terminal, a user agent, a user device, or a user equipment (UE). Or, the terminal 11 may also be a device of an unmanned aerial vehicle. Or, the terminal 11 may also be a vehicle-mounted device, such as a trip computer with a wireless communication function, or a wireless communication device connected to an external trip computer. Or, the terminal 11 may also be a roadside device, such as a streetlight, a signal light or another roadside device with a wireless communication function.

The base station 12 can be a network-side device in a wireless communication system. The wireless communication system can be a 4th generation mobile communication (4G) system, also known as a long-term evolution (LTE) system. Or, the wireless communication system may also be a 5G system, also known as a new radio (NR) system or a 5G NR system. Or, the wireless communication system may also be a next-generation system of 5G system. An access network in the 5G system can be referred to as a new generation-radio access network (NG-RAN) or a MTC system.

The base station 12 can be an evolved NodeB (eNB) in the 4G system. Or, the base station 12 may also be a gNB with a central distributed architecture in the 5G system. When the base station 12 adopts the central distributed architecture, it usually includes a central unit (CU) and at least two distributed units (DUs). The CU is provided with a protocol stack of a packet data convergence protocol (PDCP) layer, a radio link control (RLC) layer, and a media access control (MAC) layer. The DU is provided with a protocol stack of a physical (PHY) layer. A specific implementation of the base station 12 is not limited in the embodiments of the present disclosure.

A wireless connection can be established between the base station 12 and the terminal 11 through a radio air interface. In different implementations, the radio air interface is a radio air interface based on a 4th generation mobile cellular communication network technology (4G) standard. Or, the radio air interface is a radio air interface based on a 5th generation mobile cellular communication network technology (5G) standard, such as an NR. Or, the radio air interface may also be a radio air interface based on a 5G next-generation mobile cellular communication network technology standard.

In some embodiments, an end to end (E2E) connection may also be established between the terminals 11, such as a vehicle to vehicle (V2V) communication, a vehicle to infrastructure (V2I) communication and a vehicle to pedestrian (V2P) communication in a vehicle to everything (V2X) communication, and other scenarios.

In some embodiments, the above wireless communication system may further include a network management device 13.

The several base stations 12 are connected to the network management device 13, respectively. The network management device 13 can be a core network device in the wireless communication system. For example, the network management device 13 can be a mobility management entity (MME) in an evolved packet core (EPC) network. Or, the network management device may also be another core network device, such as a serving gateway (SGW), a public data network gateway (PGW), a policy and charging rules function (PCRF) unit or a home subscriber server (HSS). An implementation form of the network management device 13 is not limited in the embodiments of the present disclosure.

Execution subjects involved in the embodiments of the present disclosure include, but are not limited to, a base station and a user equipment such as a terminal of a mobile cellular communication network, and the like.

Application scenarios of the embodiments of the present disclosure include, but are not limited to, new technologies such as beamforming introduced in the 5G mobile cellular communication network, and the new technologies cause power consumption of the UE to greatly increase in a process of monitoring paging signaling.

In addition, in an indoor environment with poor signal coverage of the mobile cellular communication network, there may be occurrence of the UE failing to receive the paging signaling due to a high bit error rate.

As shown in FIG. 2, the embodiments of the present disclosure provide a network access method, and the network access method can be used in the user equipment, including:

In step 201, paging signaling of a second type network forwarded by an access point of a first type network currently accessed by the user equipment is received; and

In step 202, the second type network is accessed according to the paging signaling.

Here, the user equipment may be a device such as a terminal that can access the first type network and the second type network. The first type network may be a network which the user equipment currently accesses and with which the user equipment can normally perform communication. The second type network may use the paging signaling to instruct the user equipment to initiate a connection with an access point of the second type network. The first type network and the second type network may be networks that communicate with each other via wireless transmission.

The first type network and the second type network are different types of networks. The first type network may be a wireless communication network with a larger coverage area, and a wireless signal of the first type network has a larger transmission power. The second type network may be a wireless communication network with a smaller coverage area, and a wireless signal of the second type network has a smaller transmission power. There are many uncertain factors in a signal transmission path of the first type network due to its larger coverage area. The second type network has a relatively simple signal transmission environment due to its smaller coverage area.

The first type network and the second type network may be different types of wireless networks, for example, the first type network and the second type network support different communication protocols, and/or, the first type network and the second type network have different network architectures, and/or, the first type network and the second type network have different types of access points, etc.

The user equipment may be a device that had ever accessed the second type network and was in an idle state or a non-active state in the second type network. When the user equipment is in the idle state or the non-active state, the access point of the second type network needs to send the paging signaling or the like to wake up or activate the user equipment. The access point of the second type network may send the paging signaling to the user equipment to instruct the user equipment to initiate the connection with the access point of the second type network and to perform communication. The paging signaling may include configuration information used by the user equipment to access the second type network, and the like. The configuration information and the like may include: paging area information, paging reason information, and the like.

The access point of the second type network can directly send the paging signaling to the user equipment. However, in some scenarios in which the second type network has a poor signal, for example, the user equipment cannot receive the paging signaling of the access point of the second type network because the signal of the second type network is blocked by an object or interfered by other interference signals, the access point of the second type network may send the paging signaling to the user equipment via the first type network.

The access point of the second type network may first send the paging signaling that is intended to be sent to the user equipment to the access point of the first type network. After receiving the paging signaling of the second type network, the access point of the first type network forwards the received paging signaling of the second type network to the user equipment accessing the first type network. After receiving the paging signaling of the second type network, the user equipment sends an access request to the second type network according to the paging signaling. The access point of the second type network establishes a connection with the user equipment according to the received access request, whereby steps of accessing the second type network by the user equipment are completed.

In this way, by means of the paging signaling of the second type network forwarded by the access point of the first type network, on the one hand, another path for sending the paging signaling is provided, which improves the flexibility of selecting the path for sending the paging signaling, and when the user equipment cannot receive the paging signaling directly sent by the second type network, the paging signaling of the second type network is forwarded by the access point of the first type network, which improves a success rate of receiving the paging signaling by the user equipment, and improves the adaptability of the paging signaling transmission to the environment. On the other hand, during paging, the access point of the second type network such as the base station can send the paging signaling without using a beam sweeping manner or the like or by reducing the use of the beam sweeping manner or the like, or send the signaling by reducing the use of the beam sweeping manner or the like; and the user equipment such as the terminal can also reduce beam monitoring for the paging signaling, which in turn reduces the power consumption of the base station and the terminal.

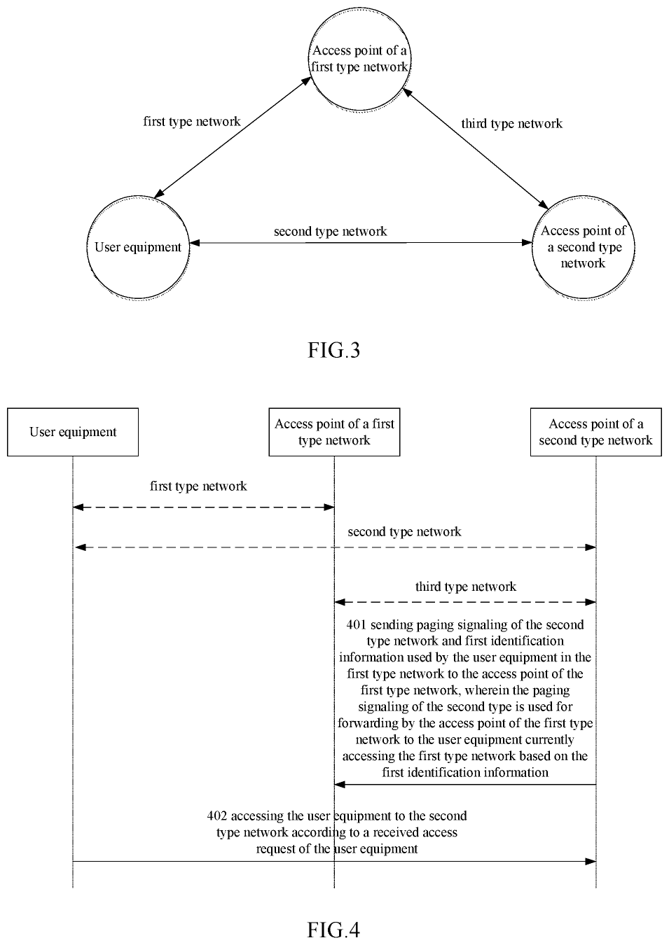

As shown in FIG. 3, a third type network may be established between the access point of the first type network and the access point of the second type network. The access point of the second type network may send the paging signaling to the access point of the first type network through the third type network. The third type network may employ the same network as or a different network from the first type network or the second type network. For example, the third type network may be a directly connected wired Ethernet, a wide area network, an optical fiber transmission network, or the like.

In an embodiment, the method further includes: receiving first identification information sent by the access point of the first type network, and the first identification information is used by the user equipment in the first type network.

The first identification information may be unique identification information of the user equipment in the first type network, which may be an inherent identity of the user equipment, such as a Wi-Fi media access control (MAC) address, etc., or may be a temporary identity allocated to the user equipment by the access point of the first type network, and so on.

Here, the first identification information may be used by the access point of the first type network to determine an object to which the paging signaling is sent. The access point of the first type network determines the user equipment to which the first identification information belongs according to the first identification information in the paging signaling, and sends the paging signaling to the user equipment.

The first identification information may be sent by the access point of the second type network to the access point of the first type network together when sending the paging signaling. The access point of the second type network may send the paging signaling and the first identification information to the access point of the first type network in a form of a paging information packet or the like. The access point of the first type network may not process the paging information packet, but directly send the paging information packet to the user equipment, and the user equipment extracts the paging signaling in the paging information packet.

The access point of the first type network may send connection condition information of the user equipment to the access point of the second type network. The connection condition information may include: the user equipment accessing the first type network, the first identification information of the user equipment accessing the first type network, and the like. The access point of the second type network may determine the user equipment accessing the first type network according to the connection condition information.

When the access point of the second type network needs to send the paging signaling to the user equipment, it can determine the access point of the first type network connected to the user equipment according to the connection condition information, and send the paging signaling to the access point of the first type network. The first identification information of the user equipment may be sent together with the paging signaling. The access point of the first type network determines the user equipment to which the first identification information belongs according to the received first identification information, and sends the paging signaling to the user equipment.

The access point of the first type network may send the first identification information of the user equipment together with the paging signaling to the user equipment. The user equipment may determine whether the received paging signaling is intended to be sent to itself according to the first identification information in the the paging signaling.

The access point of the first type network may send the connection condition information of the user equipment to the access point of the second type network through the third type network.

Respective interfaces may be set for the access point of the first type network and the access point of the second type network, respectively, in the third type network. When the paging signaling or the connection condition information is transmitted between the access point of the first type network and the access point of the second type network, the paging signaling or the connection condition information may be sent to an interface of a transmission peer.

In an embodiment, the paging signaling includes second identification information used by the user equipment in the second type network.

The second identification information may be unique identification information of the user equipment in the second type network, which may be a temporary identity allocated to the user equipment by the access point of the second type network or a physical address inherent to the user equipment. For example, the second identification information may be a temporary mobile subscriber identity (a system architecture evolution temporary mobile subscriber identity (S-TMSI)) and/or an international mobile subscriber identity (IMSI) allocated to the UE by the mobile cellular communication network.

The user equipment may determine whether the received paging signaling is intended to be sent to itself according to the second identification information in the paging signaling.

The access point of the first type network may also determine the object to which the paging signaling is sent according to the second identification information in the paging signaling, and send the paging signaling to the user equipment corresponding to the second identification information.

The access point of the second type network may store the second identification information of the user terminal when the user terminal accesses the second network for the first time.

In an embodiment, the first identification information includes a Wi-Fi media access control address of the user equipment; and

the second identification information includes a temporary mobile subscriber identity and/or an international mobile subscriber identity of the user equipment allocated by the mobile cellular communication network.

The paging signaling may include the Wi-Fi media access control (MAC) address and the temporary identity and/or the international mobile subscriber identity of the user equipment allocated by the mobile cellular communication network.

A Wi-Fi access point can determine the object to which the paging signaling is sent according to the received Wi-Fi media access control address, and send the paging signaling to the user equipment to which the Wi-Fi media access control address belongs.

In an embodiment, the first type network includes a Wi-Fi network, and the second type network includes the mobile cellular communication network.

Here, the access point of the first type network may be the Wi-Fi access point (AP) or the like. The access point of the second type network may be the base station of the mobile cellular communication network or the like. The user equipment may be a terminal with a Wi-Fi network connection capability and a mobile cellular communication network connection capability.

After the terminal accesses the mobile cellular communication network, it will migrate to the idle state or the non-active state if there is no data transmission. When there is data that needs to be sent to the terminal, the base station of the mobile cellular communication network can send the paging signaling to instruct the terminal to switch to a connected state. When switching to the connected state, the terminal needs to re-access the mobile cellular communication network for data transmission.

During the process of monitoring the paging signaling, the terminal will consume power. Especially in the 5G mobile cellular communication network, the power consumption of the terminal in the process of monitoring the paging signaling may be increased due to the use of beamforming and other technologies.

When the terminal accesses the Wi-Fi network, the base station of the mobile cellular communication network can send the paging signaling to the Wi-Fi access point, and the Wi-Fi access point forwards the paging signaling to the terminal through the Wi-Fi network. The terminal is no longer monitoring the paging signaling in the mobile cellular communication network. In this way, the power consumption of the terminal can be reduced. Likewise, the base station can no longer send the paging signaling through the beam sweeping, or can send the signaling in a manner of reducing the use of the beam sweeping, thereby reducing the power consumption of the base station.

In some scenarios in which the mobile cellular communication network has a poor signal, for example, the terminal cannot receive the paging signaling of the access point of the mobile cellular communication network because the signal of the mobile cellular communication network is blocked by an object or interfered by other interference signals. The base station of the mobile cellular communication network can send the paging signaling to the user equipment via the Wi-Fi network. In this way, the success rate of receiving the paging signaling by the terminal is improved, and the adaptability of the paging signaling transmission to the environment is improved.

Alternatively or additionally, the base station of the mobile cellular communication network and the Wi-Fi access point may establish a connection by means of the directly connected Ethernet or the wide area network. The Wi-Fi access point can send the connection condition information to the base station of the mobile cellular communication network through the directly connected Ethernet or the wide area network. The base station of the mobile cellular communication network can send the paging signaling to the Wi-Fi access point through the directly connected Ethernet or the wide area network.

In an embodiment, the receiving the paging signaling of the second type network forwarded by the access point of the first type network currently accessed by the user equipment includes at least one of the following:

receiving the paging signaling of the mobile cellular communication network carried in a management frame sent by the access point of the Wi-Fi network currently accessed by the user equipment;

receiving the paging signaling of the mobile cellular communication network carried in a control frame sent by the access point of the Wi-Fi network currently accessed by the user equipment; and

receiving the paging signaling of the mobile cellular communication network carried in a data frame sent by the access point of the Wi-Fi network currently accessed by the user equipment.

Here, when the access point of the Wi-Fi network sends the paging signaling to the user equipment, the paging signaling may be carried in the management frame, and/or the control frame, and/or the data frame and sent to the user equipment. A position of the paging signaling in the management frame, the control frame and the data frame can be pre-agreed. When receiving the management frame, the control frame and the data frame, the user equipment reads the paging signaling at the pre-agreed position.

The control frame is mainly used to assist in the transfer of the data frame and can be used to manage access to a wireless medium.

The management frame is mainly used for access management in the Wi-Fi network.

The data frame is mainly used to bear data in the Wi-Fi network.

Transmission occasions of these three Wi-Fi frames are different from each other. The use of three different frames to transmit the paging signaling can meet a real-time requirement of transmitting the paging signaling.

The management frame and/or the control frame and/or the data frame have undefined space or space that can be added for carrying the paging signaling. Using the existing management frame and/or the control frame and/or the data frame without establishing a frame dedicated to transmitting the paging signaling can improve compatibility, make the existing

Wi-Fi transmission unaffected and reduce the technical difficulty of development.

The user equipment may determine that the paging signaling is send to itself according to according to the Wi-Fi media access control address and the temporary identity and/or the international mobile subscriber identity of the user equipment allocated by the mobile cellular communication network, and access the mobile cellular communication network according to the paging signaling.

As shown in FIG. 4, the embodiments of the present disclosure provide a network access method, and the network access method can be used in an access point of a second type network, including:

In step 401, paging signaling of the second type network and first identification information used by a user equipment in a first type network are send to an access point of the first type network, and the paging signaling of the second type network is used for forwarding by the access point of the first type network to the user equipment currently accessing the first type network based on the first identification information; and

In step 402, the user equipment is made access the second type network according to a received access request of the user equipment.

Here, if the second type network is the mobile cellular communication network, the access point of the second type network may be the base station. The user equipment may be a device such as a terminal that can access the first type network and the second type network. The first type network may be a network which the user equipment currently accesses and with which the user equipment can normally perform communication. The second type network may use the paging signaling to instruct the user equipment to initiate a connection with an access point of the second type network. The first type network and the second type network may be networks that communicate with each other via wireless transmission.

The first type network and the second type network are different types of networks. The first type network may be a wireless communication network with a larger coverage area, and a wireless signal of the first type network has a larger transmission power. The second type network may be a wireless communication network with a smaller coverage area, and a wireless signal of the second type network has a smaller transmission power. There are many uncertain factors in a signal transmission path of the first type network due to its larger coverage area. The second type network has a relatively simple signal transmission environment due to its smaller coverage area.

The first type network and the second type network may be different types of wireless networks, for example, the first type network and the second type network support different communication protocols, and/or, the first type network and the second type network have different network architectures, and/or, the first type network and the second type network have different types of access points, etc.

The user equipment may be a device that had ever accessed the second type network and was in an idle state or a non-active state in the second type network. When the user equipment is in the idle state or the non-active state, the access point of the second type network needs to send the paging signaling or the like to wake up or activate the user equipment. The access point of the second type network may send the paging signaling to the user equipment to instruct the user equipment to initiate the connection with the access point of the second type network and to perform communication. The paging signaling may include configuration information used by the user equipment to access the second type network, and the like. The configuration information and the like may include: paging area information, paging reason information, and the like.

The access point of the second type network can directly send the paging signaling to the user equipment. However, in some scenarios in which the second type network has a poor signal, for example, the user equipment cannot receive the paging signaling of the access point of the second type network because the signal of the second type network is blocked by an object or interfered by other interference signals, the access point of the second type network may send the paging signaling to the user equipment via the first type network.

The access point of the second type network may first send the paging signaling that is intended to be sent to the user equipment to the access point of the first type network. After receiving the paging signaling of the second type network, the access point of the first type network forwards the received paging signaling of the second type network to the user equipment accessing the first type network. After receiving the paging signaling of the second type network, the user equipment sends an access request to the second type network according to the paging signaling. The access point of the second type network establishes a connection with the user equipment according to the received access request, whereby steps of accessing the second type network by the user equipment are completed.

The first identification information may be sent by the access point of the second type network to the access point of the first type network together when sending the paging signaling. The access point of the second type network may send the paging signaling and the first identification information to the access point of the first type network in a form of a paging information packet or the like.

The first identification information may be unique identification information of the user equipment in the first type network, which may be an inherent identity of the user equipment, such as a Wi-Fi media access control (MAC) address, etc., or may be a temporary identity allocated to the user equipment by the access point of the first type network, and so on.

Here, the first identification information may be used by the access point of the first type network to determine an object to which the paging signaling is sent. The access point of the first type network determines the user equipment to which the first identification information belongs according to the first identification information in the paging signaling, and sends the paging signaling to the user equipment.

In this way, by means of the paging signaling of the second type network forwarded by the access point of the first type network, on the one hand, another path for sending the paging signaling is provided, which improves the flexibility of selecting the path for sending the paging signaling, and when the user equipment cannot receive the paging signaling directly sent by the second type network, the paging signaling of the second type network is forwarded by the access point of the first type network, which improves a success rate of receiving the paging signaling by the user equipment, and improves the adaptability of the paging signaling transmission to the environment. On the other hand, during paging, the access point of the second type network such as the base station can send the paging signaling without using a beam sweeping manner or the like or by reducing the use of the beam sweeping manner or the like, or send the signaling by reducing the use of the beam sweeping manner or the like; and the user equipment such as the terminal can also reduce beam monitoring for the paging signaling, which in turn reduces the power consumption of the base station and the terminal.

In an embodiment, before the sending the paging signaling of the second type network to the access point of the first type network, the method further includes:

receiving connection condition information of the user equipment with the first type network sent by the access point of the first type network; and

determining the access point of the first type network currently accessed by the user equipment according to the connection condition information.

The access point of the first type network may send the connection condition information of the user equipment to the access point of the second type network. The connection condition information may include: the user equipment accessing the first type network, the first identification information of the user equipment accessing the first type network, and the like. The access point of the second type network may determine the user equipment accessing the first type network according to the connection condition information.

When the access point of the second type network needs to send the paging signaling to the user equipment, it can determine the access point of the first type network connected to the user equipment according to the connection condition information, and send the paging signaling to the access point of the first type network. The first identification information of the user equipment may be sent together with the paging signaling. The access point of the first type network determines the user equipment to which the first identification information belongs according to the received first identification information, and sends the paging signaling to the user equipment.

The access point of the first type network may send the first identification information of the user equipment together with the paging signaling to the user equipment. The user equipment may determine whether the received paging signaling is intended to be sent to itself according to the first identification information in the paging signaling.

The access point of the first type network may send the connection condition information of the user equipment to the access point of the second type network through the third type network.

Respective interfaces may be set for the access point of the first type network and the access point of the second type network, respectively, in the third type network. When the paging signaling or the connection condition information is transmitted between the access point of the first type network and the access point of the second type network, the paging signaling or the connection condition information may be sent to an interface of a transmission peer.

In an embodiment, the paging signaling includes second identification information used by the user equipment in the second type network.

The second identification information may be unique identification information of the user equipment in the second type network, which may be a temporary identity allocated to the user equipment by the access point of the second type network or a physical address inherent to the user equipment. For example, the second identification information may be a temporary mobile subscriber identity allocated to the UE by the mobile cellular communication network and/or an international mobile subscriber identity (IMSI) of the UE.

The user equipment may determine whether the received paging signaling is intended to be sent to itself according to the second identification information in the paging signaling.

The access point of the first type network may also determine the object to which the paging signaling is sent according to the second identification information in the paging signaling, and send the paging signaling to the user equipment corresponding to the second identification information.

The access point of the second type network may store the second identification information of the user terminal when the user terminal accesses the second network for the first time.

In an embodiment, the first type network is a Wi-Fi network, and the second type network is a mobile cellular communication network.

Here, the access point of the first type network may be the Wi-Fi access point (AP) or the like. The access point of the second type network may be the base station of the mobile cellular communication network or the like. The user equipment may be a terminal with a Wi-Fi network connection capability and a mobile cellular communication network connection capability.

After the terminal accesses the mobile cellular communication network, it will migrate to the idle state or the non-active state if there is no data transmission. When there is data that needs to be sent to the terminal, the base station of the mobile cellular communication network can send the paging signaling to instruct the terminal to switch to a connected state. When switching to the connected state, the terminal needs to re-access the mobile cellular communication network for data transmission.

During the process of monitoring the paging signaling, the terminal will consume power. Especially in the 5G mobile cellular communication network, the power consumption of the terminal in the process of monitoring the paging signaling may be increased due to the use of beamforming and other technologies.

When the terminal accesses the Wi-Fi network, the base station of the mobile cellular communication network can send the paging signaling to the Wi-Fi access point, and the Wi-Fi access point forwards the paging signaling to the terminal through the Wi-Fi network. The terminal is no longer monitoring the paging signaling in the mobile cellular communication network. In this way, the power consumption of the terminal can be reduced. Likewise, the base station can no longer send the paging signaling through the beam sweeping, or can send the signaling in a manner of reducing the use of the beam sweeping, thereby reducing the power consumption of the base station.

In some scenarios in which the mobile cellular communication network has a poor signal, for example, the terminal cannot receive the paging signaling of the access point of the mobile cellular communication network because the signal of the mobile cellular communication network is blocked by an object or interfered by other interference signals. The base station of the mobile cellular communication network can send the paging signaling to the user equipment via the Wi-Fi network. In this way, the success rate of receiving the paging signaling by the terminal is improved, and the adaptability of the paging signaling transmission to the environment is improved.

Alternatively or additionally, the base station of the mobile cellular communication network and the Wi-Fi access point may establish a connection by means of the directly connected Ethernet or the wide area network. The Wi-Fi access point can send the connection condition information to the base station of the mobile cellular communication network through the directly connected Ethernet or the wide area network. The base station of the mobile cellular communication network can send the paging signaling to the Wi-Fi access point through the directly connected Ethernet or the wide area network.

In an embodiment, the first identification information includes a Wi-Fi media access control address of the user equipment; and

the second identification information includes the temporary identity and/or the international mobile subscriber identity of the user equipment allocated by the mobile cellular communication network.

The paging signaling may include the Wi-Fi media access control address and the temporary identity and/or the international mobile subscriber identity of the user equipment allocated by the mobile cellular communication network.

A Wi-Fi access point can determine the object to which the paging signaling is sent according to the received Wi-Fi media access control address, and send the paging signaling to the user equipment to which the Wi-Fi media access control address belongs.

The user equipment may determine that the paging signaling is send to itself according to according to the Wi-Fi media access control address and the temporary identity and/or the international mobile subscriber identity of the user equipment allocated by the mobile cellular communication network, and access the mobile cellular communication network according to the paging signaling.

In an embodiment, the sending the paging signaling of the second type network and the first identification information to the access point of the first type network includes:

sending the paging signaling of the second type network and the first identification information to the access point of the first type network through a third network between the access point of the first type network and the access point of the second type network;

the receiving the connection condition information of the user equipment with the first type network sent by the access point of the first type network includes:

receiving the connection condition information of the user equipment with the first type network sent by the access point of the first type network through the third network.

As shown in FIG. 3, a third type network may be established between the access point of the first type network and the access point of the second type network. The access point of the second type network may send the paging signaling to the access point of the first type network through the third type network. The third type network may employ the same network as or a different network from the first type network or the second type network. For example, the third type network may be a directly connected wired Ethernet, a wide area network, an optical fiber transmission network, or the like.

The access point of the first type network may send the connection condition information of the user equipment to the access point of the second type network through the third type network.

Respective interfaces may be set for the access point of the first type network and the access point of the second type network, respectively, in the third type network. When the paging signaling or the connection condition information is transmitted between the access point of the first type network and the access point of the second type network, the paging signaling or the connection condition information may be sent to an interface of a transmission peer.

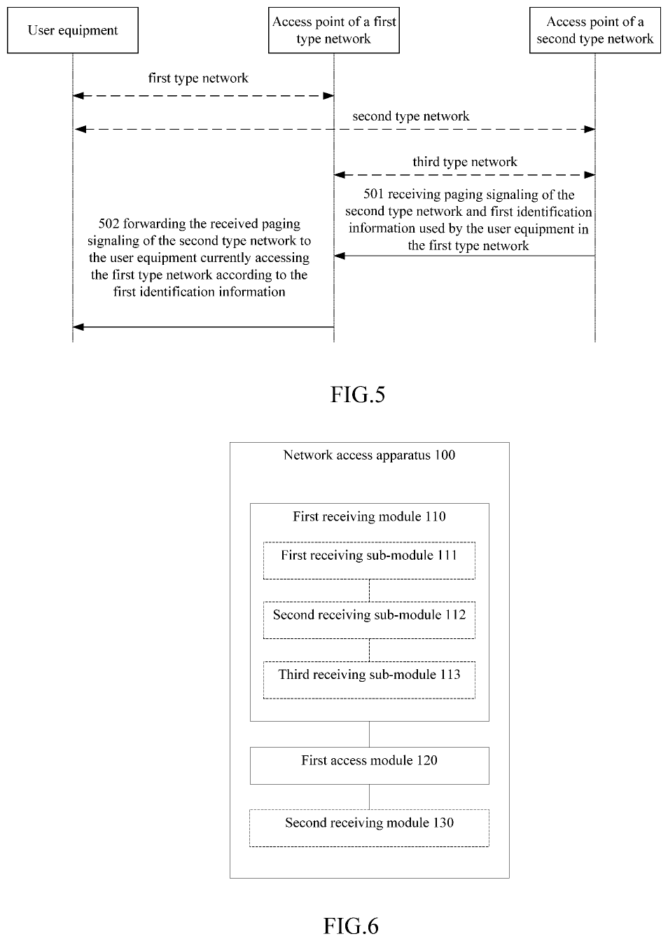

As shown in FIG. 5, the embodiments of the present disclosure provide a method for transmitting paging signaling, and the method for transmitting the paging signaling is applied to an access point of a first type network, including:

In step 501, paging signaling of a second type network and first identification information used by a user equipment in the first type network are received; and

In step 502, the received paging signaling of the second type network is forwarded to the user equipment currently accessing the first type network according to the first identification information.

Here, the access point of the first type network may be a Wi-Fi access point or the like. The user equipment may be a device such as a terminal that can access the first type network and the second type network. The first type network may be a network which the user equipment currently accesses and with which the user equipment can normally perform communication. The second type network may use the paging signaling to instruct the user equipment to initiate a connection with an access point of the second type network. The first type network and the second type network may be networks that communicate with each other via wireless transmission.

The first type network and the second type network are different types of networks. The first type network may be a wireless communication network with a larger coverage area, and a wireless signal of the first type network has a larger transmission power. The second type network may be a wireless communication network with a smaller coverage area, and a wireless signal of the second type network has a smaller transmission power. There are many uncertain factors in a signal transmission path of the first type network due to its larger coverage area. The second type network has a relatively simple signal transmission environment due to its smaller coverage area.

The first type network and the second type network may be different types of wireless networks, for example, the first type network and the second type network support different communication protocols, and/or, the first type network and the second type network have different network architectures, and/or, the first type network and the second type network have different types of access points, etc.

The user equipment may be a device that had ever accessed the second type network and was in an idle state or a non-active state in the second type network. When the user equipment is in the idle state or the non-active state, the access point of the second type network needs to send the paging signaling or the like to wake up or activate the user equipment. The access point of the second type network may send the paging signaling to the user equipment to instruct the user equipment to initiate the connection with the access point of the second type network and to perform communication. The paging signaling may include configuration information used by the user equipment to access the second type network, and the like. The configuration information and the like may include: paging area information, paging reason information, and the like.

The access point of the second type network can directly send the paging signaling to the user equipment. However, in some scenarios in which the second type network has a poor signal, for example, the user equipment cannot receive the paging signaling of the access point of the second type network because the signal of the second type network is blocked by an object or interfered by other interference signals, the access point of the second type network may send the paging signaling to the user equipment via the first type network.

The access point of the second type network may first send the paging signaling that is intended to be sent to the user equipment to the access point of the first type network. After receiving the paging signaling of the second type network, the access point of the first type network forwards the received paging signaling of the second type network to the user equipment accessing the first type network. After receiving the paging signaling of the second type network, the user equipment sends an access request to the second type network according to the paging signaling. The access point of the second type network establishes a connection with the user equipment according to the received access request, whereby steps of accessing the second type network by the user equipment are completed.

The first identification information may be sent by the access point of the second type network to the access point of the first type network together when sending the paging signaling.

The first identification information may be unique identification information of the user equipment in the first type network, which may be an inherent identity of the user equipment, such as a Wi-Fi media access control (MAC) address, etc., or may be a temporary identity allocated to the user equipment by the access point of the first type network, and so on.

Here, the first identification information may be used by the access point of the first type network to determine an object to which the paging signaling is sent. The access point of the first type network determines the user equipment to which the first identification information belongs according to the first identification information in the paging signaling, and sends the paging signaling to the user equipment.

In this way, by means of the paging signaling of the second type network forwarded by the access point of the first type network, on the one hand, another path for sending the paging signaling is provided, which improves the flexibility of selecting the path for sending the paging signaling, and when the user equipment cannot receive the paging signaling directly sent by the second type network, the paging signaling of the second type network is forwarded by the access point of the first type network, which improves a success rate of receiving the paging signaling by the user equipment, and improves the adaptability of the paging signaling transmission to the environment. On the other hand, during paging, the access point of the second type network such as the base station can send the paging signaling without using a beam sweeping manner or the like or by reducing the use of the beam sweeping manner or the like, or send the signaling by reducing the use of the beam sweeping manner or the like; and the user equipment such as the terminal can also reduce beam monitoring for the paging signaling, which in turn reduces the power consumption of the base station and the terminal.

In an embodiment, the paging signaling includes second identification information used by the user equipment in the second type network.

The second identification information may be unique identification information of the user equipment in the second type network, which may be a temporary identity allocated to the user equipment by the access point of the second type network or a physical address inherent to the user equipment. For example, the second identification information may be a temporary mobile subscriber identity allocated to the UE by the mobile cellular communication network and/or an international mobile subscriber identity (IMSI) of the UE.

The user equipment may determine whether the received paging signaling is intended to be sent to itself according to the second identification information in the paging signaling.

The access point of the first type network may also determine the object to which the paging signaling is sent according to the second identification information in the paging signaling, and send the paging signaling to the user equipment corresponding to the second identification information. The access point of the second type network may store the second identification information of the user terminal when the user terminal accesses the second network for the first time.

In an embodiment, the forwarding the received paging signaling of the second type network to the user equipment currently accessing the first type network includes:

forwarding the received paging signaling of the second type network and the received first identification information to the user equipment.

Here, the first identification information may be used by the access point of the first type network to determine an object to which the paging signaling is sent. The access point of the first type network determines the user equipment to which the first identification information belongs according to the first identification information in the paging signaling, and sends the paging signaling to the user equipment.

The first identification information may be sent by the access point of the second type network to the access point of the first type network together when sending the paging signaling. The access point of the second type network may send the paging signaling and the first identification information to the access point of the first type network in a form of a paging information packet or the like. The access point of the first type network may not process the paging information packet, but directly send the paging information packet to the user equipment, and the user equipment extracts the paging signaling in the paging information packet.

In an embodiment, the first type network is a Wi-Fi network, and the second type network is a mobile cellular communication network.

Here, the access point of the first type network may be the Wi-Fi access point (AP) or the like. The access point of the second type network may be the base station of the mobile cellular communication network or the like. The user equipment may be a terminal in the mobile cellular communication network.

After the terminal accesses the mobile cellular communication network, it will migrate to the idle state or the non-active state if there is no data transmission. When there is data that needs to be sent to the terminal, the base station of the mobile cellular communication network can send the paging signaling to instruct the terminal to switch to a connected state. When switching to the connected state, the terminal needs to re-access the mobile cellular communication network for data transmission.

During the process of monitoring the paging signaling, the terminal will consume power. Especially in the 5G mobile cellular communication network, the power consumption of the terminal in the process of monitoring the paging signaling may be increased due to the use of beamforming and other technologies.

When the terminal accesses the Wi-Fi network, the base station of the mobile cellular communication network can send the paging signaling to the Wi-Fi access point, and the Wi-Fi access point forwards the paging signaling to the terminal through the Wi-Fi network. The terminal is no longer monitoring the paging signaling in the mobile cellular communication network. In this way, the power consumption of the terminal can be reduced. Likewise, the base station can no longer send the paging signaling through the beam sweeping, or can send the signaling in a manner of reducing the use of the beam sweeping, thereby reducing the power consumption of the base station.

In some scenarios in which the mobile cellular communication network has a poor signal, for example, the terminal cannot receive the paging signaling of the access point of the mobile cellular communication network because the signal of the mobile cellular communication network is blocked by an object or interfered by other interference signals. The base station of the mobile cellular communication network can send the paging signaling to the user equipment via the Wi-Fi network. In this way, the success rate of receiving the paging signaling by the terminal is improved, and the adaptability of the paging signaling transmission to the environment is improved.

Alternatively or additionally, the base station of the mobile cellular communication network and the Wi-Fi access point may establish a connection by means of the directly connected Ethernet or the wide area network. The Wi-Fi access point can send the connection condition information to the base station of the mobile cellular communication network through the directly connected Ethernet or the wide area network. The base station of the mobile cellular communication network can send the paging signaling to the Wi-Fi access point through the directly connected Ethernet or the wide area network.

In an embodiment, the first identification information includes a Wi-Fi media access control address of the user equipment; and

the second identification information includes the temporary identity and/or the international mobile subscriber identity of the user equipment allocated by the mobile cellular communication network.

The paging signaling may include the Wi-Fi media access control address and the temporary identity and/or the international mobile subscriber identity of the user equipment allocated by the mobile cellular communication network.

A Wi-Fi access point can determine the object to which the paging signaling is sent according to the Wi-Fi media access control address in the received paging signaling, and send the paging signaling to the user equipment to which the Wi-Fi media access control address belongs.

The user equipment may determine that the paging signaling is send to itself according to according to the Wi-Fi media access control address and the temporary identity and/or the international mobile subscriber identity of the user equipment allocated by the mobile cellular communication network, and access the mobile cellular communication network according to the paging signaling.

In an embodiment, the method further includes:

sending connection condition information of the user equipment with the first type network to the access point of the second type network.

The access point of the first type network may send the connection condition information of the user equipment to the access point of the second type network. The connection condition information may include: the user equipment accessing the first type network, the first identification information of the user equipment accessing the first type network, and the like. The access point of the second type network may determine the user equipment accessing the first type network and the first identification information of the user equipment accessing the first type network according to the connection condition information.

When the access point of the second type network needs to send the paging signaling to the user equipment, it can determine the access point of the first type network connected to the user equipment according to the connection condition information, and send the paging signaling to the access point of the first type network. The first identification information of the user equipment may be sent together with the paging signaling. The access point of the first type network determines the user equipment to which the first identification information belongs according to the first identification information in the received paging signaling, and sends the paging signaling to the user equipment.

In an embodiment, the receiving the paging signaling of the second type network and the first identification information includes:

receiving the paging signaling of the second type network and the first identification information sent by the access point of the second type network through a third network between the access point of the first type network and the access point of the second type network;

the sending the connection condition information of the user equipment with the first type network to the access point of the second type network includes:

sending the connection condition information of the user equipment with the first type network to the access point of the second type network through the third network.

As shown in FIG. 3, a third type network may be established between the access point of the first type network and the access point of the second type network. The access point of the second type network may send the paging signaling to the access point of the first type network through the third type network. The third type network may employ the same network as or a different network from the first type network or the second type network. For example, the third type network may be a directly connected wired Ethernet, a wide area network, an optical fiber transmission network, or the like.

The access point of the first type network may send the connection condition information of the user equipment to the access point of the second type network through the third type network.

Respective interfaces may be set for the access point of the first type network and the access point of the second type network, respectively, in the third type network. When the paging signaling or the connection condition information is transmitted between the access point of the first type network and the access point of the second type network, the paging signaling or the connection condition information may be sent to an interface of a transmission peer.

A specific example is provided below in conjunction with any of the above-mentioned embodiments.

This example proposes a method for sending paging signaling through multi-network fusion. If the base station of the mobile communication cellular network intends to page the terminal, it can inform the connected Wi-Fi AP of the paging signaling for the terminal that it intends to page. The paging signaling may include a media access control (MAC) address of the terminal, a terminal identification (ID) used for paging, and the like. After receiving the paging signaling for paging the terminal sent by the base station, the Wi-Fi AP can send the paging signaling of the mobile communication cellular network to the corresponding terminal through the Wi-Fi network. For example, the Wi-Fi AP can send the paging signaling through the management frame, the control frames, or the data frame. After receiving the paging signaling of the mobile communication cellular network through the Wi-Fi network, the terminal determines that the mobile communication cellular network is paging itself, and then establishes the connection with the mobile communication cellular network according to the received paging signaling.

The embodiments of the present disclosure further provide a network access apparatus. FIG. 6 is a schematic structural diagram of a network access apparatus 100 according to an embodiment of the present disclosure. As shown in FIG. 6, the apparatus 100 includes a first receiving module 110 and a first access module 120.

The first receiving module 110 is configured to receive paging signaling of a second type network forwarded by an access point of a first type network currently accessed by a user equipment; and

the first access module 120 is configured to access the second type network according to the paging signaling.

In an embodiment, the apparatus 100 further includes:

a second receiving module 130, configured to receive first identification information sent by the access point of the first type network, and the first identification information is used by the user equipment in the first type network.

In an embodiment, the paging signaling includes second identification information used by the user equipment in the second type network.

In an embodiment, the first identification information includes a Wi-Fi media access control address of the user equipment; and

the second identification information includes a temporary identity and/or an international mobile subscriber identity of the user equipment allocated by a mobile cellular communication network

In an embodiment, the first type network includes a Wi-Fi network, and the second type network includes the mobile cellular communication network.

In an embodiment, the first receiving module 110 includes at least one of the following:

a first receiving sub-module 111, configured to receive the paging signaling of the mobile cellular communication network carried in a management frame sent by the access point of the Wi-Fi network currently accessed by the user equipment;

a second receiving sub-module 112, configured to receive the paging signaling of the mobile cellular communication network carried in a control frame sent by the access point of the Wi-Fi network currently accessed by the user equipment; and

a third receiving sub-module 113, configured to receive the paging signaling of the mobile cellular communication network carried in a data frame sent by the access point of the Wi-Fi network currently accessed by the user equipment.

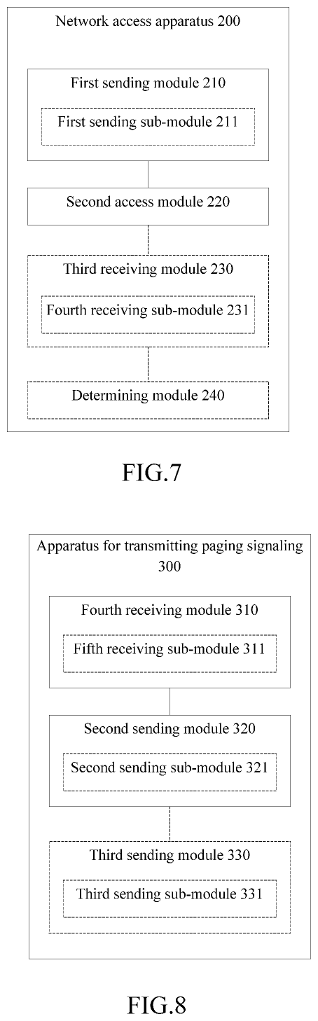

The embodiments of the present disclosure further provide a network access apparatus. FIG. 7 is a schematic structural diagram of a network access apparatus 200 according to an embodiment of the present disclosure. As shown in FIG. 7, the apparatus 200 includes a first sending module 210 and a second access module 220.

The first sending module 210 is configured to send paging signaling of a second type network and first identification information used by a user equipment in a first type network to an access point of the first type network, and the paging signaling of the second type network is used for forwarding by the access point of the first type network to the user equipment currently accessing the first type network based on the first identification information; and

the second access module 220 is configured to access the user equipment to the second type network according to a received access request of the user equipment.

In an embodiment, the apparatus 200 further includes:

a third receiving module 230, configured to receive connection condition information of the user equipment with the first type network sent by the access point of the first type network, before the paging signaling of the second type network is sent to the access point of the first type network; and

a determining module 240, configured to determine the access point of the first type network currently accessed by the user equipment according to the connection condition information.

In an embodiment, the paging signaling includes second identification information used by the user equipment in the second type network.

In an embodiment, the first type network is a Wi-Fi network, and the second type network is a mobile cellular communication network.

In an embodiment, the first identification information includes a Wi-Fi media access control address of the user equipment; and

the second identification information includes a temporary identity and/or an international mobile subscriber identity of the user equipment allocated by the mobile cellular communication network.

In an embodiment, the first sending module 210 includes:

a first sending sub-module 211, configured to send the paging signaling of the second type network and the first identification information to the access point of the first type network through a third network between the access point of the first type network and an access point of the second type network;

the third receiving module 230 includes:

a fourth receiving sub-module 231, configured to receive the connection condition information of the user equipment with the first type network sent by the access point of the first type network through the third network.

The embodiments of the present disclosure further provide an apparatus for transmitting paging signaling. FIG. 8 is a schematic structural diagram of an apparatus 300 for transmitting paging signaling according to an embodiment of the present disclosure. As shown in FIG. 8, the apparatus includes: a fourth receiving module 310 and a second sending module 320.

The fourth receiving module 310 is configured to receive paging signaling of a second type network and first identification information used by a user equipment in a first type network; and

the second sending module 320 is configured to forward the received paging signaling of the second type network to the user equipment currently accessing the first type network according to the first identification information.

In an embodiment, the paging signaling includes second identification information used by the user equipment in the second type network.

In an embodiment, the second sending module 320 includes:

a second sending sub-module 321, configured to forward the received paging signaling of the second type network and the received first identification information to the user equipment.

In an embodiment, the first type network is a Wi-Fi network, and the second type network is a mobile cellular communication network.

In an embodiment, the first identification information includes a Wi-Fi media access control address of the user equipment; and

the second identification information includes a temporary identity and/or an international mobile subscriber identity of the user equipment allocated by a mobile cellular communication network.

In an embodiment, the apparatus 300 further includes:

a third sending module 330, configured to send connection condition information of the user equipment with the first type network to an access point of the second type network.

In an embodiment, the fourth receiving module 310 includes:

a fifth receiving sub-module 311, configured to:

receive the paging signaling of the second type network and the first identification information sent by the access point of the second type network through a third network between an access point of the first type network and the access point of the second type network;

the third sending module 330 includes:

a third sending sub-module 331, configured to send the connection condition information of the user equipment with the first type network to the access point of the second type network through the third network.

In an exemplary embodiment, the first receiving module 110, the first access module 120, the second receiving module 130, the first sending module 210, the second access module 220, the third receiving module 230, the determining module 240, the four receiving module 310, the second sending module 320, the third sending module 330, etc. may be implemented with one or more Central Processing Units (CPUs), Graphics Processing Units (GPUs), Baseband Processors (BPs), Application Specific Integrated Circuits (ASICs), Digital Signal Processors (DSPs), Programmable Logic Devices (PLDs), Complex Programmable Logic Devices (CPLDs), Field-Programmable Gate Arrays (FPGAs), general-purpose processors, controllers, Micro Controller Units (MCUs), microprocessors or other electronic components, or may be implemented by incorporating one or more Radio Frequency (RF) antennas, and configured to perform the above method.

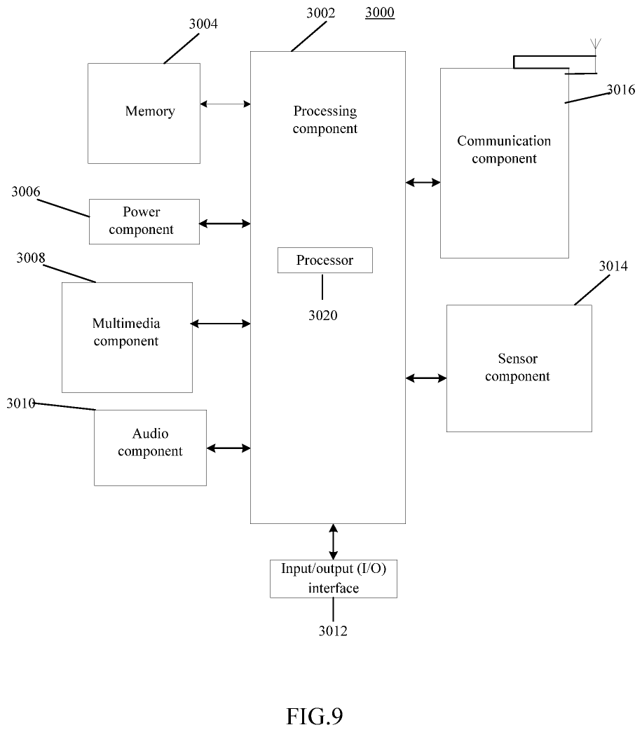

FIG. 9 is a block diagram showing an apparatus 3000 for network access according to an embodiment of the present disclosure. For example, the apparatus 3000 may be a mobile phone, a computer, a digital broadcasting terminal, a messaging device, a game console, a tablet device, a medical device, a fitness device, a personal digital assistant, etc.

Referring to FIG. 9, the apparatus 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls the overall operations of the apparatus 3000, such as the operations associated with display, telephone calls, data communications, camera operations, and recording operations. The processing component 3002 can include one or more processors 3020 to execute instructions to perform all or part of the steps in the above described methods. Moreover, the processing component 3002 can include one or more modules to facilitate the interaction between the processing component 3002 and other components. For example, the processing component 3002 can include a multimedia module to facilitate the interaction between the multimedia component 3008 and the processing component 3002.

The memory 3004 is configured to store various types of data to support the operation of the apparatus 3000. Examples of such data include instructions for any application or method operated on the apparatus 3000, such as the contact data, the phone book data, messages, pictures, videos, and the like. The memory 3004 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3006 provides power to various components of the apparatus 3000. The power component 3006 can include a power management system, one or more power sources, and other components associated with the generation, management, and distribution of power in the apparatus 3000.

The multimedia component 3008 includes a screen providing an output interface between the apparatus 3000 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 3008 includes a front camera and/or a rear camera. When the apparatus 3000 is in an operation mode, such as a photographing mode or a video mode, the front camera and/or the rear camera can receive external multimedia datum. Each of the front camera and the rear camera may be a fixed optical lens system or have focus and optical zoom capability.

The audio component 3010 is configured to output and/or input an audio signal. For example, the audio component 3010 includes a microphone (MIC) configured to receive an external audio signal when the apparatus 3000 is in an operation mode, such as a call mode, a recording mode, and a voice recognition mode. The received audio signal may be further stored in the memory 3004 or sent via the communication component 3016. In some embodiments, the audio component 3010 also includes a speaker for outputting the audio signal.

The I/O interface 3012 provides an interface between the processing component 3002 and peripheral interface modules, such as a keyboard, a click wheel, buttons, and the like. These buttons may include, but are not limited to, a home button, a volume button, a starting button, and a locking button.

The sensor component 3014 includes one or more sensors for providing status assessments of various aspects of the apparatus 3000. For example, the sensor component 3014 can detect an open/closed status of the apparatus 3000, relative positioning of components, such as the display and the keypad of the apparatus 3000. The sensor component 3014 can also detect a change in position of one component of the apparatus 3000 or the apparatus 3000, the presence or absence of user contact with the apparatus 3000, an orientation, or an acceleration/deceleration of the apparatus 3000, and a change in temperature of the apparatus 3000. The sensor component 3014 can include a proximity sensor configured to detect the presence of nearby objects without any physical contact. The sensor component 3014 can also include a light sensor, such as a CMOS or CCD image sensor, configured to use in imaging applications. In some embodiments, the sensor component 3014 can also include an accelerometer sensor, a gyroscope sensor, a magnetic sensor, a pressure sensor, or a temperature sensor.

The communication component 3016 is configured to facilitate wired or wireless communication between the apparatus 3000 and other devices. The apparatus 3000 can access a wireless network based on a communication standard, such as WiFi, 2G or 3G, or a combination thereof. In an exemplary embodiment, the communication component 3016 receives broadcast signals or broadcast associated information from an external broadcast management system via a broadcast channel. In an exemplary embodiment, the communication component 3016 also includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 3000 may be implemented with one or more application specific integrated circuits (ASICs), digital signal processors (DSPs), digital signal processing devices (DSPDs), programmable logic devices (PLDs), field programmable Gate array (FPGA), controller, microcontroller, microprocessor or other electronic components to perform the above described method.

In an exemplary embodiment, there is also provided a non-transitory computer-readable storage medium including instructions, such as a memory 3004 including instructions executable by the processor 3020 of the apparatus 3000 to perform the above described method. For example, the non-transitory computer readable storage medium may be a ROM, a random access memory (RAM), a CD-ROM, a magnetic tape, a floppy disc, and an optical data storage device.

Other embodiments of the present disclosure will be apparent to those skilled in the art from consideration of the specification and practice of the present disclosure disclosed herein. The present disclosure is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

It should be understood that the present disclosure is not limited to the precise structures that have been described above and shown in the drawings, and various modifications and changes can be made without departing from the scope thereof. The scope of the present disclosure is limited only by the appended claims.

The embodiments of the present disclosure provide a network access method and apparatus, a communication device, and a storage medium.

According to a first aspect of the embodiments of the present disclosure, there is provided a network access method, and the method includes:

receiving paging signaling of a second type network forwarded by an access point of a first type network currently accessed by a user equipment; and

accessing the second type network according to the paging signaling.

In an embodiment, the method further includes:

receiving first identification information sent by the access point of the first type network, wherein the first identification information is used by the user equipment in the first type network.

In an embodiment, the paging signaling includes second identification information used by the user equipment in the second type network.

In an embodiment, the first identification information includes a Wi-Fi media access control address of the user equipment; and

the second identification information includes a temporary identity and/or an international mobile subscriber identity of the user equipment allocated by a mobile cellular communication network.

In an embodiment, the first type network includes a Wi-Fi network, and the second type network includes the mobile cellular communication network.

In an embodiment, the receiving the paging signaling of the second type network forwarded by the access point of the first type network currently accessed by the user equipment includes at least one of the following:

receiving the paging signaling of the mobile cellular communication network carried in a management frame sent by the access point of the Wi-Fi network currently accessed by the user equipment;

receiving the paging signaling of the mobile cellular communication network carried in a control frame sent by the access point of the Wi-Fi network currently accessed by the user equipment; and

receiving the paging signaling of the mobile cellular communication network carried in a data frame sent by the access point of the Wi-Fi network currently accessed by the user equipment.

In an embodiment, the first identification information includes a Wi-Fi media access control address of the user equipment; and

the second identification information includes a temporary identity and/or an international mobile subscriber identity of the user equipment allocated by the mobile cellular communication network.

According to a second aspect of the embodiments of the present disclosure, there is provided a network access method, and the method includes:

sending paging signaling of a second type network and first identification information used by a user equipment in a first type network to an access point of the first type network, wherein the paging signaling of the second type network is used for forwarding by the access point of the first type network to the user equipment currently accessing the first type network based on the first identification information; and

accessing the user equipment to the second type network according to a received access request of the user equipment.

In an embodiment, before the sending the paging signaling of the second type network to the access point of the first type network, the method further includes:

receiving connection condition information of the user equipment with the first type network sent by the access point of the first type network; and

determining the access point of the first type network currently accessed by the user equipment according to the connection condition information.

In an embodiment, the paging signaling includes second identification information used by the user equipment in the second type network.

In an embodiment, the first type network is a Wi-Fi network, and the second type network is a mobile cellular communication network.

In an embodiment, the sending the paging signaling of the second type network and the first identification information to the access point of the first type network includes:

sending the paging signaling of the second type network and the first identification information to the access point of the first type network through a third network between an access point of the first type network and an access point of the second type network;

the receiving the connection condition information of the user equipment with the first type network sent by the access point of the first type network includes:

receiving the connection condition information of the user equipment with the first type network sent by the access point of the first type network through the third network.

According to a third aspect of the embodiments of the present disclosure, there is provided a method for transmitting paging signaling, and the method includes:

receiving paging signaling of a second type network and first identification information used by a user equipment in a first type network; and

forwarding the received paging signaling of the second type network to the user equipment currently accessing the first type network according to the first identification information.

In an embodiment, the paging signaling includes second identification information used by the user equipment in the second type network.

In an embodiment, the forwarding the received paging signaling of the second type network to the user equipment currently accessing the first type network includes:

forwarding the received paging signaling of the second type network and the received first identification information to the user equipment.

In an embodiment, the first type network is a Wi-Fi network, and the second type network is a mobile cellular communication network.

In an embodiment, the first identification information includes a Wi-Fi media access control address of the user equipment; and

the second identification information includes a temporary identity and/or an international mobile subscriber identity of the user equipment allocated by a mobile cellular communication network.

In an embodiment, the method further includes:

sending connection condition information of the user equipment with the first type network to an access point of the second type network.

In an embodiment, the receiving the paging signaling of the second type network and the first identification information includes:

receiving the paging signaling of the second type network and the first identification information sent by the access point of the second type network through a third network between an access point of the first type network and the access point of the second type network;

the sending the connection condition information of the user equipment with the first type network to the access point of the second type network includes:

sending the connection condition information of the user equipment with the first type network to the access point of the second type network through the third network.

According to a fourth aspect of the embodiments of the present disclosure, there is provided a network access apparatus, and the apparatus includes a first receiving module and a first access module, wherein:

the first receiving module is configured to receive paging signaling of a second type network forwarded by an access point of a first type network currently accessed by a user equipment; and

the first access module is configured to access the second type network according to the paging signaling.

In an embodiment, the apparatus further includes:

a second receiving module, configured to receive first identification information sent by the access point of the first type network, wherein the first identification information is used by the user equipment in the first type network.

In an embodiment, the paging signaling includes second identification information used by the user equipment in the second type network.

In an embodiment, the first identification information includes a Wi-Fi media access control address of the user equipment; and

the second identification information includes a temporary identity and/or an international mobile subscriber identity of the user equipment allocated by a mobile cellular communication network.

In an embodiment, the first type network includes a Wi-Fi network, and the second type network includes the mobile cellular communication network.

In an embodiment, the first receiving module includes at least one of the following:

a first receiving sub-module, configured to receive the paging signaling of the mobile cellular communication network carried in a management frame sent by the access point of the Wi-Fi network currently accessed by the user equipment;

a second receiving sub-module, configured to receive the paging signaling of the mobile cellular communication network carried in a control frame sent by the access point of the Wi-Fi network currently accessed by the user equipment; and

a third receiving sub-module, configured to receive the paging signaling of the mobile cellular communication network carried in a data frame sent by the access point of the Wi-Fi network currently accessed by the user equipment.

According to a fifth aspect of the embodiments of the present disclosure, there is provided a network access apparatus, and the apparatus includes a first sending module and a second access module, wherein:

the first sending module is configured to send paging signaling of a second type network and first identification information used by a user equipment in a first type network to an access point of the first type network, wherein the paging signaling of the second type network is used for forwarding by the access point of the first type network to the user equipment currently accessing the first type network based on the first identification information; and

the second access module is configured to access the user equipment to the second type network according to a received access request of the user equipment.

In an embodiment, the apparatus further includes:

a third receiving module, configured to receive connection condition information of the user equipment with the first type network sent by the access point of the first type network, before the paging signaling of the second type network is sent to the access point of the first type network; and

a determining module, configured to determine the access point of the first type network currently accessed by the user equipment according to the connection condition information.

In an embodiment, wherein the paging signaling includes second identification information used by the user equipment in the second type network.

In an embodiment, the first type network is a Wi-Fi network, and the second type network is a mobile cellular communication network.

In an embodiment, the first identification information includes a Wi-Fi media access control address of the user equipment; and

the second identification information includes a temporary identity and/or an international mobile subscriber identity of the user equipment allocated by the mobile cellular communication network.

In an embodiment, the first sending module includes:

a first sending sub-module, configured to send the paging signaling of the second type network and the first identification information to the access point of the first type network through a third network between the access point of the first type network and an access point of the second type network;

the third receiving module includes:

a fourth receiving sub-module, configured to receive the connection condition information of the user equipment with the first type network sent by the access point of the first type network through the third network.

According to a sixth aspect of the embodiments of the present disclosure, there is provided an apparatus for transmitting paging signaling, and the apparatus includes: a fourth receiving module and a second sending module, wherein:

the fourth receiving module is configured to receive paging signaling of a second type network and first identification information used by a user equipment in a first type network; and

the second sending module is configured to forward the received paging signaling of the second type network to the user equipment currently accessing the first type network according to the first identification information.

In an embodiment, the paging signaling includes second identification information used by the user equipment in the second type network.

In an embodiment, the second sending module includes:

a second sending sub-module, configured to forward the received paging signaling of the second type network and the received first identification information to the user equipment.

In an embodiment, the first type network is a Wi-Fi network, and the second type network is a mobile cellular communication network.

In an embodiment, the first identification information includes a Wi-Fi media access control address of the user equipment; and

the second identification information includes a temporary identity and/or an international mobile subscriber identity of the user equipment allocated by a mobile cellular communication network.

In an embodiment, the apparatus further includes:

a third sending module, configured to send connection condition information of the user equipment with the first type network to an access point of the second type network.

In an embodiment, the fourth receiving module includes:

a fifth receiving sub-module, configured to:

receive the paging signaling of the second type network and the first identification information sent by the access point of the second type network through a third network between an access point of the first type network and the access point of the second type network;

the third sending module includes:

a third sending sub-module, configured to send the connection condition information of the user equipment with the first type network to the access point of the second type network through the third network.

According to a seventh aspect of the embodiments of the present disclosure, there is provided a communication device including a processor, a transceiver, a memory, and an executable program stored on the memory and capable of being run by the processor, wherein the processor executes steps of the network access method described in the first aspect or the second aspect, or steps of the method for transmitting the paging signaling described in the third aspect when running the executable program.

According to an eighth aspect of the embodiments of the present disclosure, there is provided a storage medium on which an executable program is stored, wherein the executable program, when executed by the processor, implements steps of the network access method described in the first aspect or the second aspect, or steps of the method for transmitting the paging signaling described in the third aspect.

1. A network access method, comprising:
receiving paging signaling of a second type network forwarded by an access point of a first type network currently accessed by a user equipment; and
accessing, by the user equipment, the second type network according to the paging signaling.

2. The method according to claim 1, further comprising:
receiving first identification information sent by the access point of the first type network, wherein the first identification information is configured for the user equipment in the first type network.

3. The method according to claim 2, wherein the paging signaling comprises second identification information configured for the user equipment in the second type network.

4. The method according to claim 3, wherein,
the first identification information comprises a Wireless Fidelity (Wi-Fi) media access control address of the user equipment; and
the second identification information comprises a temporary identity or an international mobile subscriber identity of the user equipment allocated by a mobile cellular communication network.

5. The method according to claim 1, wherein the first type network comprises a Wi-Fi network, and the second type network comprises a mobile cellular communication network.

6. The method according to claim 5, wherein the receiving the paging signaling of the second type network forwarded by the access point of the first type network currently accessed by the user equipment comprises at least one of the following:
receiving the paging signaling of the mobile cellular communication network carried in a management frame sent by the access point of the Wi-Fi network currently accessed by the user equipment;
receiving the paging signaling of the mobile cellular communication network carried in a control frame sent by the access point of the Wi-Fi network currently accessed by the user equipment; or
receiving the paging signaling of the mobile cellular communication network carried in a data frame sent by the access point of the Wi-Fi network currently accessed by the user equipment.

7. A network access method, comprising:
sending paging signaling of a second type network and first identification information configured for a user equipment in a first type network to an access point of the first type network, wherein the paging signaling of the second type network is configured for forwarding by the access point of the first type network to the user equipment currently accessing the first type network based on the first identification information; and
accessing the user equipment to the second type network according to a received access request of the user equipment.

8. The method according to claim 7, wherein before the sending the paging signaling of the second type network to the access point of the first type network, the method further comprises:
receiving connection condition information of the user equipment with the first type network sent by the access point of the first type network; and
determining the access point of the first type network currently accessed by the user equipment according to the connection condition information.

9. The method according to claim 7, wherein the paging signaling comprises second identification information configured for the user equipment in the second type network.

10. The method according to claim 9, wherein the first type network is a Wireless Fidelity (Wi-Fi) network, and the second type network is a mobile cellular communication network.

11. The method according to claim 10, wherein,
the first identification information comprises a Wi-Fi media access control address of the user equipment; and
the second identification information comprises a temporary identity or an international mobile subscriber identity of the user equipment allocated by the mobile cellular communication network.

12. The method according to claim 9, wherein,
sending the paging signaling of the second type network and the first identification information to the access point of the first type network comprises:
sending the paging signaling of the second type network and the first identification information to the access point of the first type network through a third network between the access point of the first type network and an access point of the second type network; and
wherein receiving the connection condition information of the user equipment with the first type network sent by the access point of the first type network comprises:
receiving the connection condition information of the user equipment with the first type network sent by the access point of the first type network through the third network.

13. A method for transmitting paging signaling, comprising:
receiving paging signaling of a second type network and first identification information configured for a user equipment in a first type network; and
forwarding the received paging signaling of the second type network to the user equipment currently accessing the first type network according to the first identification information.

14. The method according to claim 13, wherein the paging signaling comprises second identification information used by the user equipment in the second type network.

15. The method according to claim 14, wherein forwarding the received paging signaling of the second type network to the user equipment currently accessing the first type network comprises:
forwarding the received paging signaling of the second type network and the received first identification information to the user equipment.

16. The method according to claim 15, wherein the first type network is a Wireless Fidelity (Wi-Fi) network, and the second type network is a mobile cellular communication network.

17. The method according to claim 16, wherein,
the first identification information comprises a Wi-Fi media access control address of the user equipment; and
the second identification information comprises a temporary identity and/or an international mobile subscriber identity of the user equipment allocated by the mobile cellular communication network.

18. The method according to claim 13, further comprising:
sending connection condition information of the user equipment with the first type network to an access point of the second type network.

19. The method according to claim 18, wherein,
receiving the paging signaling of the second type network and the first identification information comprises:
receiving the paging signaling of the second type network and the first identification information sent by the access point of the second type network through a third network between an access point of the first type network and the access point of the second type network; and
wherein sending the connection condition information of the user equipment with the first type network to the access point of the second type network comprises:
sending the connection condition information of the user equipment with the first type network to the access point of the second type network through the third network.

20-38. (canceled)

39. A communication device, comprising a processor, a transceiver, a memory, and an executable program stored on the memory and capable of being executed by the processor, wherein the processor, when running the executable program, executes steps of the network access method according to claim 1.

40. (canceled)
